(19) United States
(12) Patent Application Publication
(10) Pub. No.: US 2010/0083799 A1
(43) Pub. Date: Apr. 8, 2010

(54) Device for inner turning

(76) Inventor: Giannino Santiglia, Fosso' (IT)

Correspondence Address: Themis Law, 7660 Fay Ave Ste H-535, La Jolla, CA, 92037, US

(21) Appl. No.: 12/524,143

(22) PCT Filed: Jan. 29, 2007
(86) PCT No.: PCT/IT07/00059

§ 371 Date: Aug. 8, 2009

(51) Int. Cl. B23B 29/034

(52) U.S. Cl. 82/1.4

(57) ABSTRACT

The invention relates to a device, rotating and with variable diameter, for the inner machining of pieces. In one embodiment, the device includes a fixing body, a rotating support generally in the shape of a cup suited to house a tool carrier spindle and set it in rotation, and a mechanism for the radial translation of the tool carrier spindle in the cup-shaped rotating support. The tool carrier spindle is housed in the cup-shaped support and translates in a radial direction with respect to the axis of the cup-shaped support. The cup-shaped rotating support rotates around its own axis and is preferably set in rotation by a stepping or variable-speed electric motor controlled via PLC.

### FIELD OF THE INVENTION

The present invention concerns turning centers, and in particular concerns a new device that can be applied to the bed of mechanical machining stations.

### BACKGROUND OF THE INVENTION

For precision machining of metal, plastic or other materials, machine tools are known that carry out turning, milling, rectifying, welding operations etc. for making components of various types.

Said machine tools are very widespread in the mechanical industry and in small, medium and large enterprises.

NC machine tools are known, that is, automated machines equipped with PLC (Programmable Logic Controller) units for programming and managing the machining parameters, also having the function of signaling any anomaly occurring during operation and request maintenance.

The operator, therefore, can use said PLC units to control several parameters related to the displacement of the moving parts, the type of tool required, the wear of the tools, the error parameters, etc.

Said tools are contained in special seats, called tool holder stations, located in sections of the machine tool commonly called tool cribs.

The machine tools of known types comprise one or more moving headstocks, suited to position and handle the tools and/or the objects to be machined.

The machine tools of known type comprise also one or more motors with the corresponding drive elements suited to transmit motion to said moving components.

In particular, machine tools are known, which are specifically used to carry out turning operations on objects of various types and are commonly called turning centers.

Said turning centers usually comprise one or more carriages, for example translating horizontally on one or more slideways, equipped with headstock with a rotating spindle for positioning and fixing the turning tools.

Said rotating spindle places the object in a given position and sets the object rotating around its own longitudinal axis.

Said turning centers also include a further auxiliary spindle, or tailstock, that grips the opposite end of the object to be machined, or in any case keeps it centered, in order to keep it in the correct position by following with minimum friction the rotary movement transmitted by said rotating spindle.

The known turning centers also comprise one or more translating tool holder turrets, equipped with several moving plates having a plurality of seats for inserting and fixing the turning tools.

Said tools are positioned with the nose directed toward the outer surface of the object to be turned. The displacement of the tool holder turret and of the tool is parallel and/or perpendicular to the rotation axis of the object to be turned.

The object that revolves around its own longitudinal axis due to the rotary movement transmitted by said rotating spindle is thus externally machined by said tools and the desired turning is thus obtained.

One of the worst drawbacks of known turning centers is that it is not possible to turn the outer and the inner surface of an object at the same time, which means increasing considerably, and often even doubling, machining times.

Furthermore, known turning centers do not allow eccentric inside turning, that is, turning on an axis parallel to the rotation axis. To obtain this type of machining would require placing the piece in eccentric position on the tool holder spindle, if the spindle allows it, but there are considerable problems due to the eccentric mass of the piece that rotates at high speed.

Machine tools are known for eccentric turning of pieces, which use an arm equipped with a tool holder spindle translated by motors or electromechanical numerical control mechanisms along the Y and Z directions of the plane orthogonal to the X-axis of the hole or seat to be obtained. Even if the movements of said tool holder spindle are very slight, when said machining stations are used, the machined inner surface has rough or uneven points due to the synchronous, but independent movements in the two directions YZ. Therefore, the inner surface obtained in this manner successively requires one or more finishing operations.

Other types of stations for the mechanical machining of pieces allow an inner turning of the pieces. Said machining stations comprise a tool holder spindle that is translated along the XYZ axes by stepping precision motors.

Even if the movements induced by said motors are very precise and slight, the machined inner surface has rough or uneven points due to the synchronous but independent movements in the two directions YZ. Furthermore, said inside machining may require a lot of time, depending on the dimensions of the area to be machined and of the tool.

### SUMMARY OF THE INVENTION

To overcome the above-mentioned drawbacks, a new type of numerical control device with PLC, rotating and with variable diameter, for the inside machining of pieces, has been designed and constructed.

The main aim of the present invention is to allow turning operations to be carried out both on the outer surface and on the inner surface of the object, which means saving time and increasing productivity.

Another aim of the present invention is to enable turning operations to be carried out on inner surfaces and cavities in various types of objects.

Another aim of the present invention is to control, through a single PLC unit, the turning operation on both the outer and the inner surface of the object.

Another aim of the present invention is to enable turning operations to be carried out on objects with different diameters with no need to use different tools.

Another aim of the present invention is to enable the inside turning diameter to be varied even during operation of the device.

A further aim of the present invention is to enable machining operations to be carried out also eccentrically with respect to the rotation axis of the rotating spindle of the turning center.

Another aim of the present invention is to make it possible to carry out inside turning operations that do not require further machining or finishing operations on the inner surface that is obtained.

These and other direct and complementary aims have been achieved through the development of a new type of numerical control device with PLC, rotating and with variable diameter, for the inner machining of pieces.

Said rotating device can be installed on known machine tools for turning various types of objects, or on turning centers, or even on other stations for the mechanical machining of pieces.

Said rotating device can be installed on a turret, a carriage or another moving device suited to position said rotating device inside a cavity of the object to be turned.

The new rotating device can be used for turning the surface of the inner cavity and the outer surface of the object at the same time.

This way, machining times are optimized and machining can furthermore be controlled through a single PLC unit.

If the inner turning is carried out at the same time as the outside turning, since the outer surface to be turned and the surface of the inner cavity rotate at different linear speeds due to their different distances from the rotation axis, it is possible to regulate the rotational speed of said new device to obtain as a whole the optimal value of the relative rotational speed between the object to be turned and the inner turning tool.

In particular, it is preferable for the rotation direction of said rotating device to be opposite to the rotation direction of said rotating spindle. This way, it is possible to maintain the preset relative rotational speed by reducing the absolute rotational speed of the rotating device, with consequent possible advantages like reduced wear and reduced consumption.

Said new rotating device includes in its main parts a fixing body for application to the machining station, a rotating support generally in the shape of a cup suited to house the tool holder spindle and set it rotating, and a mechanism for the radial translation of said tool carrier spindle in the cup-shaped rotating support.

The tool holder spindle is housed in the cup-shaped support and can translate along one or more recesses, slideways or other elements for the forced linear sliding in radial direction with respect to the axis of the cup-shaped support.

The cup-shaped rotating support rotates around its own axis and is set in rotation, directly or through gears or other drive means, preferably by a stepping or variable-speed electric motor controlled via a PLC.

If the new device is assembled on a turning center, it is preferable for the rotation axis of the cup-shaped support to coincide with the axis of the piece holder spindle of the turning center.

The mechanism for radial translation of the tool holder spindle in the cup-shaped support is provided by an element that translates axially in the cup-shaped support, and is provided with a sliding plane that is inclined with respect to said rotation axis of the cup-shaped support facing the tool holder spindle. Said inclined sliding plane is such to adhere to and slide on a corresponding sliding plane present on the side of the tool holder spindle inside the cup-shaped support.

Both the tool holder spindle and said translating element of the translating mechanism of the tool holder spindle rotate together with the cup-shaped support.

The translation of said element with inclined sliding plane having a radial translation mechanism of the tool holder spindle is such that, moving said element with inclined sliding plane toward the opening for insertion of the tool causes a sliding the two inclined planes and thus a translation of the tool holder spindle away from the center of the cup-shaped support. In the same way, the translation of the element with sliding plane away from the opening for insertion of the tool allows the tool holder spindle to move in the direction of the center of the cup-shaped support.

The cup-shaped support of the new rotating device rotates around its own longitudinal axis, consequently causing the rotation of the tool that, when in contact with the inner surface of the object, machines it as desired.

The distance between the tool and the center of the cup-shaped support can be varied even during operation of the device itself.

According to the invention, a counterweight, that is, a mass corresponding to the weight of the tool, is applied to an element that translates radially in the cup-shaped support in the direction opposite to that of the spindle, in such a way to make up for the rotating eccentric mass of the tool. Said counterweight can be loaded automatically in the tool crib during loading of the machining tool.

According to the invention, the new device may be installed on a carriage that translates along the rotation axis of the piece to be turned.

Furthermore, always according to the invention, said new device may be installed on said carriage by means of translating and/or rotating slideways, in such a way to allow machining to be carried out parallel to the rotation axis of the piece and/or on axes that are inclined with respect to said rotation axis of the piece. In said situations, when the inner turning is carried out eccentrically and/or in an inclined position, the piece to be turned must necessarily be still and must not rotate.

The features of the new rotating device with variable diameter, numerically controlled through PLC for the inner machining of pieces, will be highlighted in greater detail in the following description of a non-limiting embodiment of the invention, with reference to the enclosed drawings.

### BRIEF DESCRIPTION OF THE DRAWINGS

FIG. 1 shows an overall view of a device according to the invention,

FIGS. 2a and 2b show two partial sections along two planes square to the rotation axis,

FIG. 3 shows a schematic view of the main inner parts of the cup-shaped support (T), and

FIG. 4 shows a rotating device according to the invention installed on a turning center.

### DETAILED DESCRIPTION OF THE INVENTION

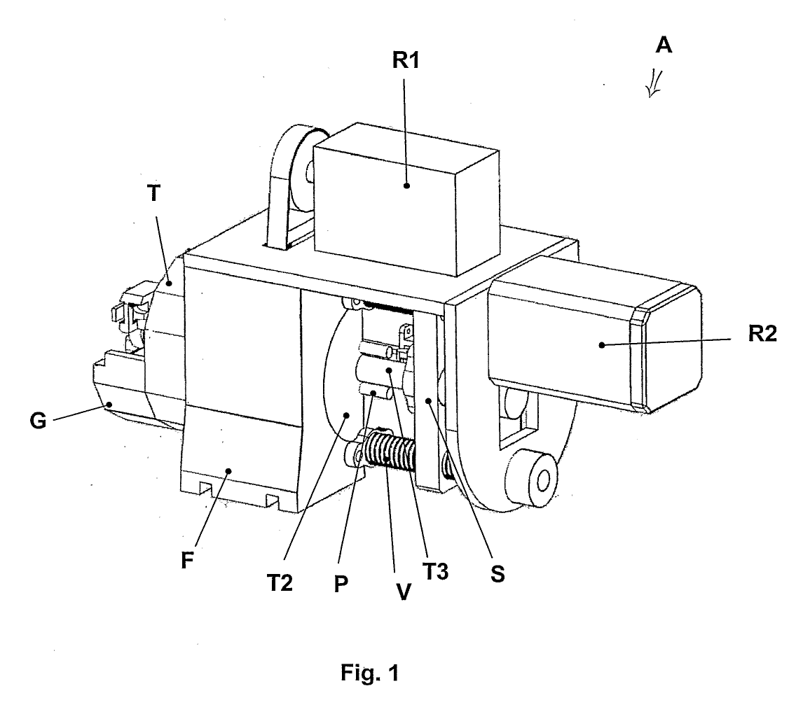

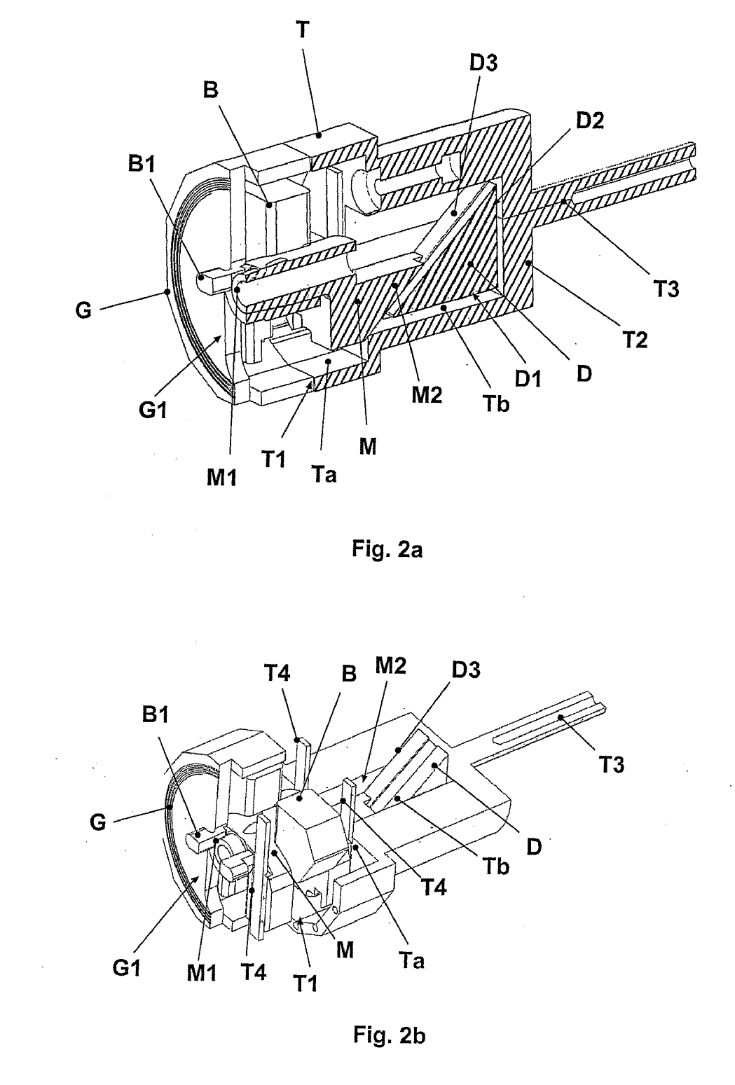

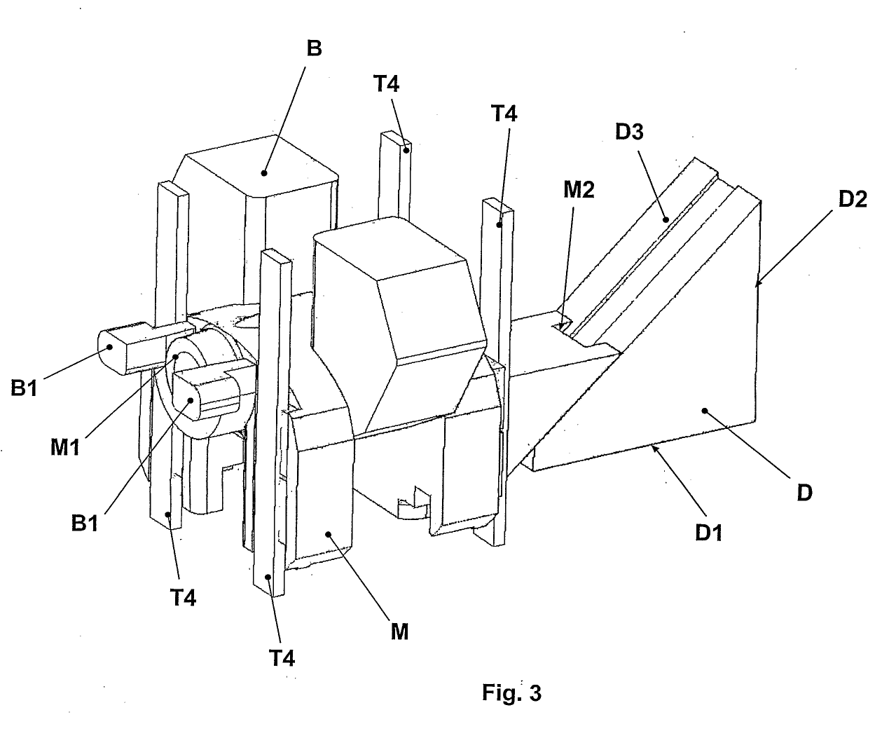

Referring first to FIGS. 1-3, a new rotating device (A) according to the invention includes a fixing body (F) suited to allow application of the new device (A) to a piece machining station and to support all the parts of the device.

Said fixing body (F) houses a cup-shaped support (T) that rotates on the fixing body (F) and has a hollow cylindrical shape, open on one open circular side (T1) and having a central pin or tang (T3) on the other, closed circular side (T2).

The inner hollow volume of the cup-shaped support (T) is ideally divided into a front space (Ta) near the open circular side (T1) of the cup-shaped support (T), and a rear space (Tb) near the closed circular side (T2) of said cup-shaped support (T).

The front space (Ta) is substantially cylindrical and coaxial to the cup-shaped support (T); the rear space (Tb) is parallelepiped with rectangular section developing parallel to the axis of the cup-shaped support (T).

In the front space (Ta) of the cup-shaped support (T) there is a tool holder spindle (M) consisting of a front housing (M1) for inserting and fixing the tool and a rear part shaped as an inclined sliding plane (M2).

In the front space (Ta) there are also recesses, slideways, tracks (T4) or other elements for forced linear sliding that are such to allow said tool holder spindle (M) to translate only in a radial direction inside said front space (Ta).

On the open circular side (T1) of the cup-shaped support (T) there is a closing metal ring (G) with radial opening (G1) such as to allow insertion of the tool in the front housing (M1) of the tool holder spindle and the radial sliding of said tool and of the part of the spindle (M) projecting from said metal ring (G).

In the rear space (Tb) of the cup-shaped support (T) there is a translating element (D) generically parallelepiped in shape, with a right-angled triangle section, which has two sides (D 1, D2) square to each other and arranged so that one of them (D 1) faces the closed circular side (T2) of the cup-shaped support (T) and the other one (D2) faces the side of the rear space (Tb). The inclined side (D3), included between said two square sides (D 1, D2), faces the sliding plane (M2) of the tool holder spindle (M) and is parallel to it.

Said translating element (D) is suited to slide inside the rear space (Tb) of the cup-shaped support (T) only along a direction parallel to the axis of said cup-shaped support (T).

The sliding plane (M2) of the tool holder spindle (M) and the inclined side (D3) of the translating element (D) are such to rest and slide on each other.

On the closed circular side (T2) of the cup-shaped support there are at least two thrusting pins (P) parallel to the axis of the cup-shaped support (T), which rest on the translating element (D) inside the cup-shaped support (T), passing through said closed circular side (T2) and extending toward the central pin or tang (T3) of the cup-shaped support (T).

Pushing the accessible ends of said thrusting pins (P) means causes a movement of said translating element (D) toward the tool holder spindle (M).

As a consequence of said pushing action and due to the shape and arrangement of the sliding plane (M2) of the tool holder spindle (M) and of the inclined side (D3) of the translating element (D), the tool holder spindle (M) translates radially with respect to the cup-shaped support (T) along the recesses, slideways, tracks (T4) or other elements suited to ensure a forced linear sliding.

According to the invention, the inside of the front space (Ta) can be provided with a balancing element (B) suited to be translated radially, at the same time and preferably covering the same distance, in a direction opposite to that of the tool holder spindle (M), in such a way as to balance the masses that move around the axis of the cup-shaped support (T).

Said balancing element (B) is provided with projections (B1) that are accessible and protrude from the metal ring (G), to which counterweights are applied and fixed having a mass similar to the mass of the tool inserted in the spindle (M).

A device, mechanism or other element sets the cup-shaped support (T) in rotation. In this example, a stepping or variable-speed electric motor (R1) controlled via PLC and applied to the fixing body (F) is connected to the cup-shaped support (T), directly or through gears or other drive means.

The fixing body (F) is provided with a mechanism for operating the thrusting pins (P) of the cup-shaped support (T).

Said operating mechanism comprises, in this example, a plate (S) inserted in and square to the central pin or tang (T3) of the cup-shaped support (T). Said plate (S) is moved along said central pin or tang (T3) of the cup-shaped support (T) by two worm screws (V) fitting in two appropriate holes in said plate (S) and operated by a second stepping electric motor (R2) controlled via PLC and preferably applied to the fixing body (F).

The rotation of the motor (R2) and of the worm screws (V) causes the displacement of said plate (S) on the central pin or tang (T3) of the cup-shaped support (T), pushing said thrusting pins (P) and thus moving the tool holder spindle (M) radially in the cup-shaped support (T).

According to the invention, said radial translation of the spindle (M) also causes, directly or through special mechanisms, the translation of the balancing element (B) and of the counterweights applied to it.

Said counterweights can be loaded automatically from the tool crib: each time a tool is loaded, beside or near it there are corresponding counterweights that are coupled and/or fixed to the projections (81) of the balancing element (B).

The new device (A) can be installed on any numerical control station with PLC for the mechanical machining of pieces. This example illustrates its assembly on a turning station, but the above considerations apply also in case of assembly on other types of mechanical machining stations.

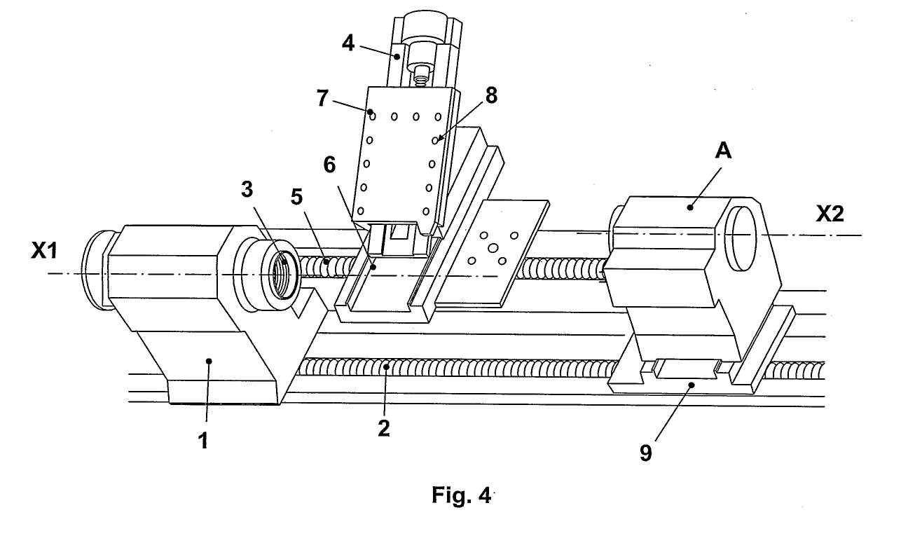

FIG. 4 shows an embodiment of the new rotating device (A) installed on a turning center comprising at least one carriage (1), fixed or translating on slideways (2), with a rotating spindle (3) for fixing and rotating the objects to be turned.

Said object is inserted in said fixing rotating spindle (3) and arranged in a position that is suitable for the specific operations to be carried out.

Said turning center also includes one or more moving turrets (4), translating and/or rotating-translating on slideways (5, 6), to which one or more tool holder stations (7) are connected, said stations being provided with seats (8) for inserting and fixing the outside turning tools.

Said turret (4) and said carriage (1) with rotating spindle (3) perform controlled translation and/or rotation movements, suited to position and handle properly the object to be machined and the tools to be used.

In particular, said turret (4) is used to carry out turning operations on the outer surface of the object.

Said rotating spindle (3) transmits a suitable rotating movement to the object to be turned, so that the bit of the tool, placed in contact with the outer surface of the object, machines the surface of the object.

The turning center may comprise a further carriage translating on slideways with tailstock, having the function of keeping the object in the correct position during machining.

Said new rotating device (A) can be installed on an additional turret or preferably an additional carriage (9) or another moving device suited to position the new rotating device (A) inside the cavity of the object to be turned.

The inner turning of the object is thus obtained by inserting said rotating device (A) in the cavity to be turned and arranging it properly, so that the bit of the tool (U) is in contact with the inner surface of the cavity.

If the inner turning is carried out at the same time as the outer turning, the object to be machined is set rotating around its axis (X1) by said rotating spindle (3) of the turning center, while the tool installed on the new device is set rotating on its axis (X2) by the cup-shaped support (T) and by the relevant motor (A1).

Since the outer surface to be turned and the surface of the inner cavity rotate at different linear speeds, due to their differing distances from the rotation axis (X1), it is possible to regulate the rotational speed of said new device (A) to obtain as a whole the optimal value of the relative rotational speed between the object and the inner hulling tool.

In particular, it is preferable for the rotation direction of said rotating device (A) to be opposite to the rotation direction of said rotating spindle (3). This way, it is possible to maintain the preset relative rotational speed by reducing the absolute rotational speed of the rotating device (A), with consequent possible advantages like reduced wear and reduced consumption.

Furthermore, always according to the invention, the new device (A) is installed on the translating carriage (9) by means of translating and/or rotating slideways and/or supports, in such a way to allow machining to be carried out parallel to the rotation axis (X1) of the piece and/or on axes that are inclined with respect to said rotation axis (X1) of the piece. In said cases, when the inner turning is carried out eccentrically and/or in an inclined position, the piece to be turned must necessarily be still and must not rotate.

According to the invention, said rotating device (A) can be removed from the corresponding carriage (9) or turret on which it is installed, and be automatically replaced by other devices or tools, or by a tailstock, placed in -suitable tool cribs of the turning center.

These are the schematic characteristics that are sufficient to carry out the invention for a person skilled in the art, consequently upon construction changes may be made that do not affect the substance of the innovative concept disclosed herein.

Therefore, with reference to the above description and the attached drawings, the following claims are expressed.

What is claimed is:

1. A device for inner and outer turning, the device being installable on a carriage and/or on a turret translating and/or rotating on slideways of a mechanical machining station, comprising:
a tool for inner turning that is adapted to rotate around a longitudinal rotational axis, the longitudinal axis being parallel to a rotation axis of an object to be turned, the object being rotatable with a rotational speed different from a rotation speed of the object to be machined.

2. The device according to claim 1, wherein the device is configured to provide a relative rotational speed between the object to be turned and said tool that is a vector sum of the absolute rotational speed of said object around the rotation axis of the object and the absolute rotational speed of said tool around their own the rotation axis of the tool.

3. The device according to claim 1, further comprising:
a fixing body suited to support the device and to allow application of the device to the mechanical machining station;
a generically cylindrical cup-shaped support;
a tool holder spindle translating radially in said cup-shaped support;
a mechanism for a translation of said tool holder spindle in said cup-shaped support;
first means for rotating said cup-shaped support; and
second means for radially translating said tool holder spindle,
wherein said fixing body is installed on or applied to the mechanical machining station so that a rotation axis of the cup-shaped support is parallel to a rotation axis of a piece holder spindle of the machining station, and
wherein a front housing for inserting and fixing the tool of the tool holder spindle is in facing relationship with the piece holder spindle of the machining station.

4. The device according to claim 3, wherein the rotation axis of the cup-shaped support coincides with the rotation axis of the piece holder spindle of the machining station.

5. The device according to claim 3, wherein the cup-shaped support is configured to rotate with an angular speed that differs from an angular speed of the piece holder spindle of the machining station.

6. The device according to claim 3, wherein the cup-shaped support is configured to rotate in a direction opposite to a rotational direction of the piece holder spindle of the machining station.

7. The device according to claim 3,
wherein said cup-shaped support has a cylindrical hollow shape, the cup-shaped support being open on a circular side and having a central pin or tang on an opposite closed circular side, and
wherein an inner hollow volume of said cup-shaped support defines a substantially cylindrical front space coaxial with the cup-shaped support and adjacent the open circular side of the cup-shaped support, and a rear space adjacent the closed circular side of said cup-shaped support and substantially parallelepiped in shape, the rear space being disposed along the rotation axis of said cup-shaped support.

8. The device according to claim 7,
wherein the tool holder spindle comprises the front housing for inserting and fixing the tool and of a rear part shaped as an inclined sliding plane, and
wherein the tool holder spindle is housed in the front space of the cup-shaped support and slides on apposite recesses, slideways, tracks or other elements for a forced linear sliding that are such to allow said tool holder spindle to translate only in radial direction inside said front space of the cup-shaped support.

9. The device according to claim 7, wherein the translation mechanism of the tool holder spindle comprises a translating element suited to slide in the rear space of the cup-shaped support, the translation mechanism having an inclined side suited to rest and slide on the inclined plane of said tool holder spindle, so that a translation parallel to the rotation axis of said cup-shaped support causes a translation of said tool holder spindle in a direction square to said rotation axis of the cup-shaped support.

10. The device according to claim 9,
wherein the translation mechanism of the tool holder spindle comprises at least two thrusting pins parallel to the rotation axis of the cup-shaped support, the at least two thrusting pins resting on the translating element inside the cup-shaped support, passing through said closed circular side and extending toward the central pin or tang of the cup-shaped support, and
wherein a plate disposed square to the rotation axis of the cup-shaped support and translated parallel to said rotation axis of the cup-shaped support causes a translation of said thrusting pins and consequently a translation of the translating element.

11. The device according to claim 10, wherein said cup-shaped support is set rotating by a stepping or variable-speed electric motor controlled via a programmable logic controller.

12. The device according to the claim 10,
wherein said plate is translated parallel to the rotation axis of the cup-shaped support by at least two worm screws meshing with said plate, and
wherein at least one of said worm screws is set rotating by a stepping or variable-speed electric motor controlled via a programmable logic controller.

13. The device according to claim 7, further comprising a balancing element housed in the front space of the cup-shaped support and translating radially at the same time as the tool holder spindle but in an opposite direction.

14. The device according to claim 13, wherein said balancing element is provided with one or more projections that protrude from a metal ring disposed in the open circular side and that are suited to support and hold counterweight masses corresponding to a mass of the tool fitted in the tool holder spindle.

15. The device according to claim 14, wherein said counterweight masses are loaded and unloaded automatically in/from a tool crib each time the tool is installed on and removed from the tool holder spindle.
